(19) United States
(12) Patent Application Publication
(10) Pub. No.: US 2026/0268372 A1
(43) Pub. Date: Sep. 10, 2026

(54) COMMUNITY DIGITAL WALLET AND REWARDS

(71) Applicant: Main Street Payments, LLC, New York, NY (US)

(72) Inventor: Eldon Scott, New York, NY (US)

(21) Appl. No.: 19/559,768

(22) Filed: Mar. 6, 2026

Related U.S. Application Data
(60) Provisional application No. 63/767,848, filed on Mar. 6, 2025.

(51) Int. Cl. G06Q 30/0251; G06Q 30/0207

(52) U.S. Cl. CPC G06Q 30/0259; G06Q 30/0239

(57) ABSTRACT

Systems and methods for tracking usage of community-based digital campaigns are provided. Information may be stored in memory regarding different communities each associated with a geographic location and set of community-based entities at the geographic location. Interaction data may be captured by a digital wallet application of a user device and sent over a communication network where such data may indicate a geographic location of the interaction between the user device and an entity system. One of the communities may be determined to be associated with the indicated geographic location, and the entity system indicated by the interaction data may be verified as associated with one of the community-based entities in the stored set for the determined community. The verified interaction data may then be associated with other verified interaction data regarding past interactions between the user device and community-based entities in the set associated with the determined community.

### CROSS-REFERENCE TO RELATED APPLICATIONS

The present patent application claims the priority benefit of U.S. Provisional Patent Application No. 63/767,848 filed Mar. 6, 2025, the disclosure of which is incorporated by reference herein.

### BACKGROUND OF THE CLAIMED INVENTION

### 1. Field of the Disclosure

The present disclosure is generally related to community digital wallet applications, particularly tracking and analyzing usage thereof with different organizations and entities located within a community using community digital wallets.

### 2. Description of the Related Art

Local community-based organizations—including brick-and-mortar offices and storefronts belonging to local businesses, nonprofits, charities, etc.—are often at a disadvantage when competing with online retailers and service providers, which are able to develop their own mobile applications, online portals, and websites. This, combined with the dominance of large chain retailers, has made it difficult for smaller, local organizations to compete for user engagement. These larger retailers may be able to use economies of scale, technical resources, and tools to attract, engage, and retain customers, donors, volunteers, and other types of users and user engagement.

Past systems of retaining or incentivizing customers may include physical or digital loyalty cards (e.g., punch cards), whereby certain numbers of uses (e.g., punches in the punch card) may be rewarded. Such prior art punch cards may be susceptible to fraud if the punch cards or punches may be counterfeited, however, and small or nonprofit organizations often cannot afford to keep offering rewards that are not the result of legitimate repeat business, donations, volunteerism, or other community interaction. Even if an independent small organization had the resources to develop its own mobile or other digital application or website, the technical and rewards offerings may be much sparser in comparison to larger, for-profit businesses, which consequently reduces the opportunities to retain or otherwise incentivize repeat interactions. In addition, the friction involved in downloading, registering, and remembering to use a separate digital applications may be a deterrent to engagement and interaction.

There is, therefore a need in the art for improved systems and methods of providing, tracking and analyzing digital interactions on a community-wide basis without requiring each business to individually track and verify the same. The presently-disclosed systems and methods further do not require users to download, register with, or maintain multiple different mobile applications on their respective mobile device in order to participate and engage with multiple different local businesses in a coordinated and cohesive fashion. Thus, the user is not required to open, launch, and navigate through different mobile applications and their respective different interfaces and tools in order to access similar data, tools, functions, etc., in relation to different community organizations.

### SUMMARY OF THE CLAIMED INVENTION

Systems and methods for tracking usage of community-based digital campaigns are provided. Information may be stored in memory regarding different communities each associated with a geographic location and set of community-based entities at the geographic location. Interaction data may be captured by a digital wallet application of a user device and sent over a communication network where such data may indicate a geographic location of the interaction between the user device and an entity system. One of the communities may be determined to be associated with the indicated geographic location, and the entity system indicated by the interaction data may be verified as associated with one of the community-based entities in the stored set for the determined community. The verified interaction data may then be associated with other verified interaction data regarding past interactions between the user device and community-based entities in the set associated with the determined community.

### BRIEF DESCRIPTIONS OF THE DRAWINGS

FIG. 1 illustrates an exemplary network environment in which a community-based digital campaign system may be implemented.

FIG. 2 illustrate scatter plot maps illustrating exemplary correlations between different entity interactions in a community.

FIG. 3 is a flowchart illustrating an exemplary method for operating a community digital wallet.

FIG. 4 is a flowchart illustrating an exemplary method for managing user accounts used for community digital wallets.

FIG. 5 is a flowchart illustrating an exemplary method for deploying new digital community campaigns.

FIG. 6 is a flowchart illustrating an exemplary method for generating AI-based recommendations for community digital wallet usage.

FIG. 7 is a flowchart illustrating an exemplary method for tracking recommendation conversion.

FIG. 8 is a flowchart illustrating an exemplary method for tracking community rewards for community digital wallet usage.

FIG. 9 is a block diagram of an exemplary computing device that may be used to implement an embodiment of the present invention.

### DETAILED DESCRIPTION

Embodiments of the present disclosure include systems and methods for tracking interaction with community-based digital campaigns. Information may be stored in memory regarding different communities each associated with a geographic location and set of community-based entities at the geographic location. Interaction data may be captured by a digital wallet application of a user device and sent over a communication network where such data may indicate a geographic location of the interaction between the user device and an entity system. One of the communities may be determined to be associated with the indicated geographic location, and the entity system indicated by the interaction data may be verified as associated with one of the community-based entities in the stored set for the determined community. The verified interaction data may then be associated with other verified interaction data regarding past interactions between the user device and community-based entities in the set associated with the determined community.

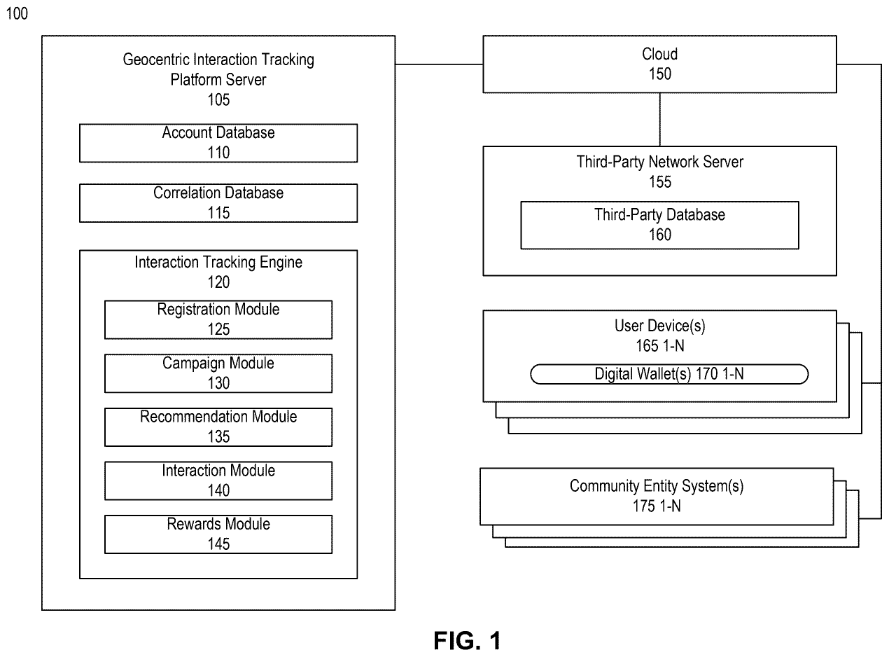

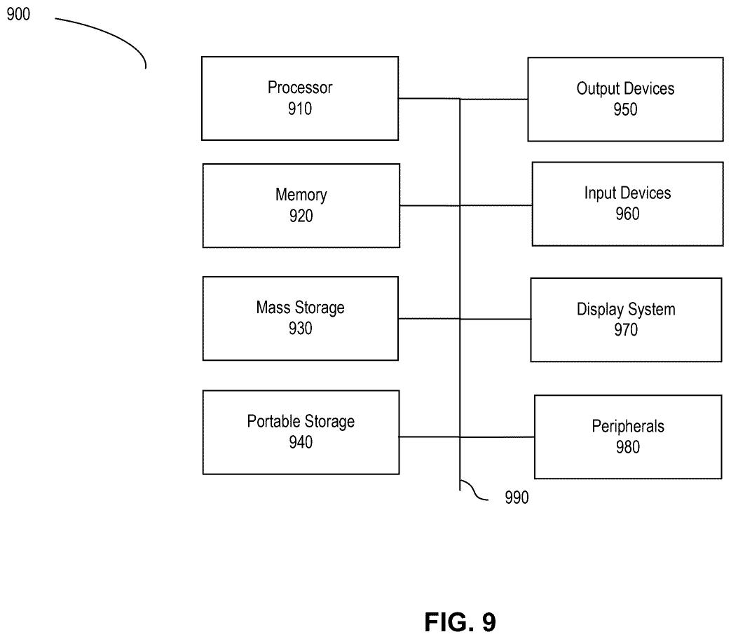

FIG. 1 illustrates an exemplary network environment 100 in which a community-based digital campaign system may be implemented. Network environment 100 may include a number of different network devices such as geocentric interaction tracking platform server 105, third-party network server 155, user device(s) 165, and community entity system(s) 175, each of which may communicate with each other device via the internet or cloud 150. Each of the network devices may be computing device such as described in further detail in relation to FIG. 9.

A community may be defined based on a specified geographic location, geofences, or other indicators of local presence. Within the location associated with a specific community, there may be a number of participating users of the user devices 165 and community-based entities operating community entity systems 175. Such entities may be inclusive of any organization, businesses, nonprofits, etc., having a physical footprint or base of operations at the specified geographic location.

A geocentric interaction tracking platform server 105 may service a plurality of geographic locations corresponding to one or more different communities. In some embodiments, the geographic location may comprise a municipality such as a town or city. In other embodiments, the geographic location may comprise a neighborhood within a larger city or urban area. Such a neighborhood may be as small as a city block or street. In further embodiments, the geographic location may comprise a school district or a shopping complex. In some embodiments, a geographic location may comprise a collection of multiple neighborhoods or communities which may be individually geographically constrained, but otherwise grouped to form a collective. For example, several neighborhoods across a single county may join to form a single collective utilizing the geocentric interaction tracking platform server 105.

In some embodiments, the geocentric interaction tracking platform server 105 may host data regarding several geographic locations which may or may not collectively coordinate community-based campaigns. Unique rewards systems may exist for each unique community or neighborhood, which may or may not be transferable. Depending on the specific community campaign, rewards may be earned based on progress toward campaign goals and tracked in terms of points, actions, or other indicators of achievement and progress. The rewards may be exchanged for status, privileges, or physical or other types of rewards. For example, rewards may be exchanged for reward currencies such as cryptocurrencies. In an embodiment, a cryptocurrency may be a stable coin indexed to another currency or other asset. Transferable currencies may be subject to an exchange rate if used outside of the community or neighborhood in which it was earned. Nontransferable currencies and rewards may be used only within the community or neighborhood in which it was earned. In some embodiments, the value of a balance of community-specific digital currency may be represented in a user's digital wallet as an equivalent value in the dominant currency of the region, such as US dollars.

The account database 110 stores account data relating to users of a geocentric interaction tracking platform server 105. User data may include user account and authentication information, contact information, user device 165 information, digital wallet 170 information, associated communities, community campaigns in which the user is participating, progress within each campaign, etc. The account database 110 may additionally store information relating to one or more campaigns including the type of campaign, organizers, participants, beneficiaries, etc. Additional campaign information may include one or more promotions, incentives, conditions, etc., which may include qualification criteria, for what interactions qualify under the terms of the promotion or incentives. In some embodiments, the campaigns may comprise an event or fund-raising effort including raising funds for a local organization such as a local baseball team. Campaigns may additionally include a budget that may be comprised of an amount of a community-specific cryptocurrency.

Table 1 illustrates an exemplary account database 110.

TABLE 1

| Account | Transaction | Transaction | Vendor | Campaign | | Reward |
|---|---|---|---|---|---|---|
| ID | ID | Amount | ID | ID | Campaign Description | Amount |
| A-005 | T-001 | $ 20.00 | Loc-003 | C-001 | Double rewards promotior | $ 1.20 |
| A-001 | T-002 | $ 35.64 | Loc-005 | C-002 | Baseball Fund Raiser | $ 1.07 |
| A-004 | T-003 | $ 45.00 | Loc-056 | C-003 | Food Shelf Promotior | $ 1.35 |
| A-002 | T-004 | $ 98.46 | Loc-094 | | N/A | $ 2.95 |
| A-002 | T-005 | $ 131.84 | Loc-163 | C-001 | Double rewards promotior | $ 7.91 |
| A-004 | T-006 | $ 74.57 | Loc-065 | | N/A | $ 2.24 |
| A-001 | T-007 | $ 88.79 | NL-03516 | | N/A | $ 13.32 |

As illustrated in Table 1, the account database 110 may store account data for the geocentric interaction tracking platform server 105. The data may include personal data, such as account identification and authentication information, personal contact and billing information, as well as one or more payment methods. The payment methods may include information establishing a link to a third-party database 124 or a third-party network server 155 to facilitate transactions via a financial institution such as a bank, credit union, or credit card service. The account database 110 may additionally store data relating to a community-specific digital currency. In some embodiments, this digital currency may comprise a cryptocurrency. In other embodiments, the digital currency may be an analog of a traditional currency, such as the United States dollar. The account database 110 may be populated and used by the funding module 110, interaction module 140, and rewards module 145. In some embodiments, the account database 110 may additionally be populated and used by the campaign module 130 to create, store, and manage one or more campaigns.

The correlation database 115 stores data relating to correlations representing relationships between user behaviors and products and services users may be interested in purchasing. Examples of user behaviors may include products and services interacted, vendors visited or interacted from, internet browser search history, etc. User behaviors may additionally include community events including campaigns, promotional events, fund raisers, etc., in which a user may have participated. Products and services may include any product or service offered by a local community or neighborhood business. In some embodiments, local products and services may include products offered from affiliated non-local vendors such as ecommerce retailers. The correlation database 115 may additionally store correlations between user behaviors and campaigns, such as marketing or promotional campaigns, fundraising efforts, etc.

In some embodiments, the correlations may be used to train an artificial intelligence model to make predictions as to previously unidentified correlations. The artificial intelligence model may include a large language model that may provide a simplified user interface for receiving information regarding a user or a first interaction and that may generate predictions as to correlations for other users or other interactions. In other embodiments, the artificial intelligence model may recognize and report potentially fraudulent transactions or behaviors. In some embodiments, the artificial intelligence model may use available data, such as location, user preferences, or real-time interaction data, to identify recommendations for the user as to community entities, events, and activities for interaction within the user's proximity or associated community.

The interaction tracking engine 120 initiates execution of the registration module 125 which may authenticate a user, as well as their respective user device 165 and digital wallet 170. During registration, the user device 165 may be queried as to geographic location, community details, device applications, and other account preferences. Such data may be stored in account database 110 in association with a user account. If the user does not have an account, an account may be created and stored in account database 110. The user account may thus be associated with a specific digital wallet application used to participate in community-based interactions.

The registration module 125 may receive and compare user data with data in the account database 110 to determine whether the user has a pre-existing user account. If the user does not have an account, a new account may be created. The user is then authorized before receiving a digital wallet 170 to associate with the user's account. The registration module 125 may additionally receive account preferences, such as additional authorized users which may include a spouse or children, and restrictions which may be placed on usage of the account, such as at only local vendors within the neighborhood or community. The account preferences may additionally include organizations they wish to support via campaigns.

The campaign module 130 may allow user devices 165 or entity systems 175 to guide creators through the progress of creating a community-based campaigns, as well as allow a user device 165 to select campaigns in which to participate. A campaign may be defined as a set of rules specifying which interactions with which community-based entities may earn a certain set of rewards. The campaign module 130 may include, for example, user interfaces that present options for communities, community-based entities, user qualifications, and types of interactions to participate in a community-based campaign to incentivize interactions with local organizations. Options may also be based on past campaigns with previously-made selections for the same. A campaign creator may select from among such options, and campaign module 130 may assess the selections, e.g., for consistency, up-to-date data, and generate a set of rules based on the selections. Such a digital campaign may be created, for example, in association with community-based events, fundraisers, etc. For example, a digital campaign for a specific community may specify that a certain reward (e.g., number of points) may be earned by attending a local event, patronizing a local business, donating, fundraising, or volunteering at a local nonprofit organization, or otherwise engaging in a local activity, as well as redemptions for the rewards.

The campaign module 130 allows users to create a campaign, such as a marketing or promotional campaign or a fundraising campaign, community events, etc. Campaigns may comprise promotions at a single local vendor or may comprise an organized promotional event where sales are offered by multiple participating vendors. Campaigns may comprise discounts, increased rewards, etc. Campaigns may additionally be organized to sponsor a community event, fundraiser, charity, etc. For example, a campaign may comprise a food drive for a local food shelf. A campaign may alternatively comprise a fundraiser for a local high school baseball team. A campaign may comprise a promotional campaign where a interaction at a first vendor may allow the user to qualify for a discount at a second vendor. In some embodiments, the campaign module 130 may allow a user to select campaigns of interest in which to participate. The campaign data is generated and saved to an account database 110, as well as sent to user device 165.

A digital interaction campaign may be generated and analyzed by recommendation module 135, which uses a recommendation engine, such as a machine learning or artificial intelligence model, to recommend one or more other entities or interactions for the campaign. The recommendation module 135 uses previous interaction data to train the recommendation engine, update the correlation database 115, generate new recommendations, and send notifications regarding the recommendations to the user device 165, and track interactions via the digital wallet application 170, which detects when the user device 165 interacts with one or more community entity systems 175. Such interactions may include checking-in to a particular local establishment, conducting a transaction, or other type of interactions, each of which may be associated with or trigger generation of interaction data and metadata associated with the interaction.

The recommendation module 135 uses data from the account database 110 and correlation database 115 to train a recommendation engine. The recommendation engine may be a machine learning algorithm or artificial intelligence model which may use methods such as regression, to create and update correlations which represent the relationship between one or more user behaviors and products, services, or campaigns which may interest one or more users. The correlations represent a quantifiable relationship between user behaviors and products and services. Multiple correlations may be used to create high order vectors to simultaneously consider multiple user behaviors when recommending a product or service allowing the recommendation engine to recommend products based on users with similar user behaviors. The trained recommendation engine may then be used to predict recommendations that may interest a user. In some embodiments, users may provide feedback such as by purchasing a recommended product from a particular community shop, or otherwise indicating that they are interested in the product. Alternatively, the user may indicate that the recommended product or service is not of interest. The trained recommendation engine and recommendations are saved to the correlation database 115.

The interaction module 140 uses a recommendation engine to generate one or more recommended products or services which are displayed to a user. The user may select one or more products or services which may include one or more recommended products or services. The user may select the products via the geocentric interaction tracking platform server 105 or may select the products or services at a physical location at a local vendor within the community or neighborhood. The vendors and/or products and services may qualify for one or more active campaigns which may provide discounts to the interaction price for the selected products and services or impact the amount of rewards which may result from the interaction, or funds which may be donated on behalf of the user to one or more organizations as part of a campaign or fundraiser. User confirmation may be received, which may include wallet-based verification of user presence or funds, which are used to confirm the interaction. The interaction data is saved to the account database 110.

The rewards module 145 receives interaction data and campaign data from the account database 110 which is used to determine whether the transaction qualifies for one or more campaigns. Campaigns may impact the amount of rewards distributed to the user, or may identify an alternate recipient for the rewards. For example, if a community business is patronized with as part of a campaign raising funds for a local high school baseball team or local food shelf, the rewards earned from the transaction may instead be distributed to the organization raising funds. A reward amount is determined, which may be dependent on qualifying campaigns, organizations, vendors, products and services purchased, etc. For example, a default reward rate of 3% may apply to the total interaction price from local vendors within a community or neighborhood, whereas the default reward rate for non-local interactions may be only 1.5%. Likewise, a campaign which promises double rewards may then provide 6% of the interaction price for qualified interactions from local vendors. In addition to the reward amount, the recipient may be determined, such as whether the rewards will be paid to the user or to another organization. Likewise, the method of payment may be determined, such as via a discount on future interactions, credit provided via a digital wallet, or a geocentric interaction tracking platform server 105 specific cryptocurrency. The rewards are distributed and saved to the account database 110.

The interaction data may be sent to the rewards module 145 is initiated which determines a reward amount to credit to the user's digital wallet, or alternatively to the user's recipient of choice, such as a community organization which may be raising funds, such as a local food shelf or a high school baseball team. The geocentric interaction tracking platform server 105 may be used to store rewards which may be issued to the user by the rewards module 145 in return for interactions by the user.

A cloud 150 is a distributed network of computational and data storage resources which may be available via the internet or by a local network. A cloud 150 accessible via the internet is generally referred to as a public cloud whereas a cloud 150 on a local network is generally referred to as a private cloud. A cloud 150 may further be protected by encrypting data and requiring user authentication prior to accessing its resources.

A third-party network server 155 is comprised of one or more network resources owned by another party. For example, a third-party network server 155 may refer to a non-local vendor who may be affiliated with, or whose products may be sponsored by a local vendor within a neighborhood. In an embodiment, a third-party network may be Amazon.com and its associated resources. Third-party products sponsored by local vendors may be offered for sale by the local vendors via a geocentric ecommerce platform, but may not be in the local vendor's inventory, but may instead be drop shipped, or interacted by the local vendor on a customer's behalf. Other examples of third-party networks may comprise marketing services, financial services including clearing houses and financial institutions. A third-party database 124 stores data owned by another party. For example, a third-party database 124 may store or access data on a third-party network server 155, such as a non-local vendor's inventory. In an embodiment, a third-party database 124 may include online marketplaces such as Amazon, eBay, Newegg, etc. In some embodiments, a third-party database 124 may be operated and maintained by a manufacturer.

While existing digital wallet applications 170 may be used in conjunction with the community interaction tracking discussed herein, some implementations may include a dedicated community digital wallet 170 for community-based tracking. In some implementations, the user may optionally specify what digital wallets 170 are available on their user devices 165, which payment methods to associate with their digital wallet 170, and other preferences provided to the geocentric interaction tracking platform server 105. A digital wallet 170 may be populated with funds from a bank account, via a cash deposit, or via extension of a line of credit. In some embodiments, the user may associate other financial service accounts, such as bank accounts, credit cards, etc., which may be used instead of directly funding a digital wallet 170 on the geocentric interaction tracking platform server 105.

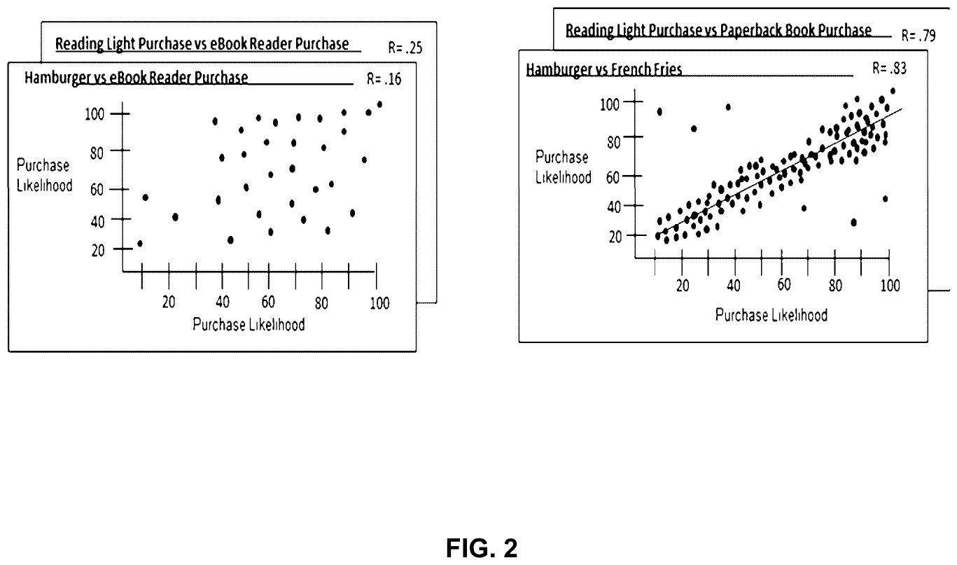

FIG. 2 illustrate scatter plot maps illustrating exemplary correlations between different entity interactions in a community. Such correlations may be stored in correlation database 115, as well as machine learning algorithms, and/or artificial intelligence models, which utilize the correlations to provide recommendations to users based on previous behaviors. The correlations represent relationships between users' behaviors, such as items viewed, interacted, vendors, visited, etc., and items they may similarly be interested in purchasing based on similar users' behaviors. The correlation database 115 is populated and used by the recommendation module 135 and may additionally be used by the interaction module 140.

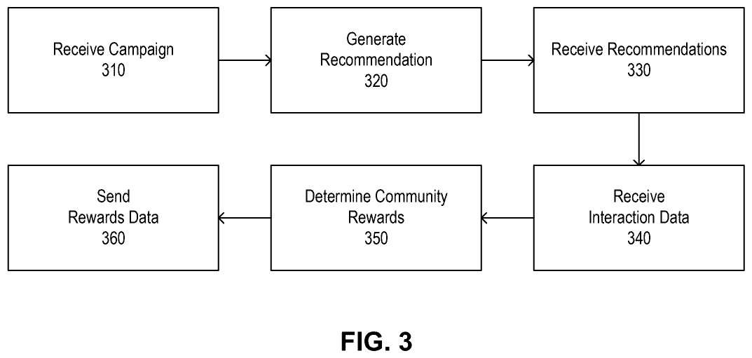

FIG. 3 is a flowchart illustrating an exemplary method for operating a community digital wallet, which may result from execution of interaction tracking engine 120. Upon being executed in step 310, interaction tracking engine 120 may call on registration module 125 to prompt and receive user data, which may be captured at a user device 165 via a mobile device application, other computer, or point of sale device and used to register a user and user device for community-based interaction tracking. The account database 110 is queried and it is determined whether the user has an account stored in the account database 110. If an account does not exist associated with the user, a new user account is created. The user data is used to authenticate the user, such as by comparing a username and password to data stored in the account database 110. One or more digital wallets may also be registered for use in community-based interaction tracking. Such digital wallets may include payment methods, such as a credit card, bank account number, credit card number, and/or a peer-to-peer payment system such as PayPal, Venmo, or Zelle. Digital wallets allow for secure exchanges of information and confirmation of actions and transactions without exposing such data to entity systems 175, thereby further reducing the risk of exposing such data to unauthorized parties or systems. Additional account preferences may be received, such as secondary users. Examples of secondary users may comprise a spouse or children. The received data may include user information, account authorization data, and account preferences, are saved to the account database 110.

In step 320, the campaign module 130 may be execute, thus facilitating streamlined campaign generation. Examples of campaigns may include rules and parameters defining the specific interactions and entities involved in the campaign. The created campaign and related campaign data may be saved to the account database 110, as well as provided to user devices 165 of participating users and respective digital wallets 170.

In step 330, the recommendation module 135 may be executed by a processor of platform server 105 to query account database 110 and correlation database 115, as well as to use data from the account database 110 to update the correlation data stored in the correlation database 115 via a process of training a recommendation engine. A recommendation engine may comprise a machine learning or artificial intelligence model comprising algorithms and stored parameter data. The stored parameter data may comprise high dimensional vectors representing the relationships between different products, user behaviors, etc. The recommendation engine is then used to predict one or more recommendations for a specific user. The recommendations are saved to the correlation database 115. One or more interaction recommendations may be generated by the recommendation module 135 and provided to user device 165. The recommendations may indicate one or more interactions, transactions, or other action, e.g., associated with specified products, services, vendors, promotions, community events, fundraising campaigns, etc., that would result in progress toward one or more rewards. The recommendations may be specific to the user, their preferences, real-time geographic location, previous interactions by the same user or other users identified as similar or associated with similar interaction behaviors. The recommendations may alternatively comprise fraud detection or customized pricing. The generated recommendations are displayed by the user device 165. In some embodiments, the generated recommendations may be retrieved from the correlation database 115. In other embodiments, the recommendations may be dynamically generated by a recommendation engine.

In step 340, data regarding one or more interactions may be received from a user device 165 identified as being located in a specific geographic location. The interaction data may further identify one or more entity systems 175 with which the user device 165 has interacted. In some embodiments, the interaction may comprise a selection to make a donation to a community fundraiser or charity. The donation may be confirmed by the digital wallet, which may further provide data that can be used by geocentric interaction tracking platform server 105 digital wallet, reward credit, geocentric interaction tracking platform server 105 currency such as a cryptocurrency, credit card, bank account information, etc. The transaction is executed, which may include submitting a transaction request to a financial service clearing house. The interaction data is saved to the account database 110. The interaction data may also indicate specific products and/or services involved in the transaction.

In step 350, the rewards module 145 may be executed by a processor of platform server 105 to query the account database 110 for transaction and campaign data. One or more campaigns for which the transaction may qualify may be identified, which may impact the reward amount or the beneficiary of the award. The reward amount is then determined, which may be based on any of the vendors, campaigns, types of products, etc. In some embodiments, the reward amount may be determined based on a default rate, such as 3%, if the transaction is not associated with a campaign. In another embodiment, the rate may be determined by the campaign, such as offering double rewards, which may then double the default 3% reward amount to 6% of the interaction price. The rewards data may then be distributed to the user device 165, or alternatively to a beneficiary device indicated by the user or the campaign that the transaction qualified. For example, the user may have selected to donate their earned rewards to a local fundraising effort, such as for a local high school baseball team. Alternatively, the transaction may have been made as a part of a campaign to raise funds or donations for a local food shelf. The rewards data may comprise a new balance for a digital wallet or other rewards tracking ledger, including those associated with specific currency, such as a cryptocurrency. In some embodiments, the rewards may comprise available discounts or credits towards future interactions.

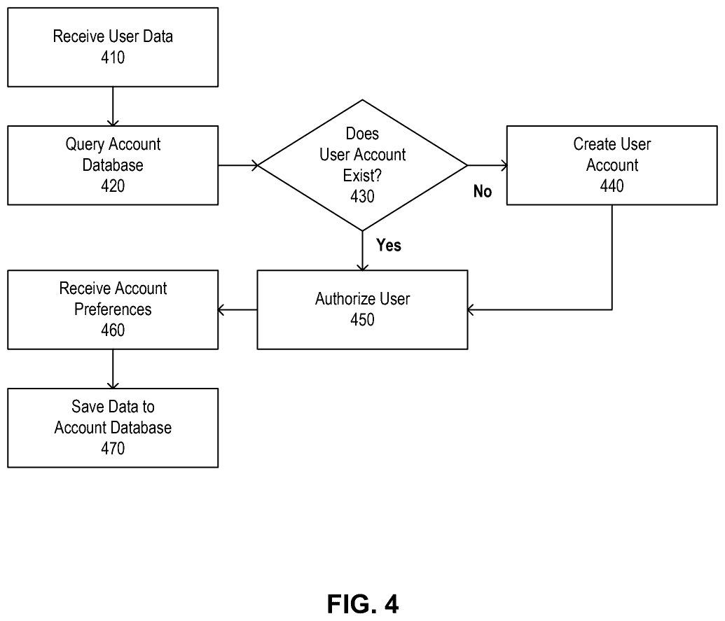

FIG. 4 is a flowchart illustrating an exemplary method for managing user accounts used for community digital wallets. The process begins with at step 410, in which the registration module 125 is called by the interaction tracking engine 120 and executed. The user data may be received from user device 165, e.g., as entered by a user via a web browser, mobile application, or other device application. In an embodiment, the data may be received via a smartphone. In another embodiment, the user data may be received from a point-of-sale device. The user data may be provided by a third party, such as a cashier, customer service representative, or other employee of a business or vendor. The user data may comprise at least a unique identifier, personal information, and/or contact information. For example, the unique identifier may comprise an email address. In other embodiments, the unique identifier may comprise a username or ID comprising a unique string of alphanumeric characters, which may be automatically generated and assigned to the user. In some embodiments, the user data may additionally comprise a password, pin number, and/or biometric data, which may be used to authenticate the user. Biometric data may include a fingerprint scanner, iris scanner, facial information from a camera, etc.

In step 420, the account database 110 may be queried for data matching the received user data. The received data may comprise any of, an account identification number, electronic wallet ID, username, email address, name, phone number, physical and/or mailing address, etc.

The account database 110 may further be queried for additional forms of identification or personal information that may have been received from the user, such as a password, pin number, and other means of verifying the user data.

In step 430, it may be determined whether a user account for a user of the user device 165 exists in account database 110. The user account exists if determined to be already present in the account database 110, e.g., by comparing personal data received from or about a user with data stored in the account database 110 and identifying matching data. In some embodiments, determining whether a user exists may comprise comparing a username with the usernames stored in the account database 110. The user is determined to exist if an account with the same username is stored in the account database 110. If a matching username is not found stored in the account database 110, the account does not exist. In some embodiments, data other than a username may be used similarly to determine whether a user exists. For example, an email address or phone number may be used as a unique identifier, which should be associated with only one account. In some embodiments, multiple fields may be used to determine whether an account exists, such as the user's name and phone number.

If a user account does not exist in account database 110, the method proceeds to step 440, where a new user account may be created. Creating a new user account may comprise receiving user data, which may include personal and contact information such as a name, email address, phone number, physical and/or mailing address, etc. Creating an account may further comprise the creation of a digital wallet for storing digital currency, which may include cryptocurrency.

In step 450, the user is authorized if the received user authentication data matches the authentication data stored in the account database 110 or a third-party database 124 maintained by a third-party network server 155 providing user authentication services. Examples of third-party networks 122 providing authentication services are Google, Microsoft, and Apple, which provide single sign-on user authentication. In some embodiments, the user authentication data may comprise a password, pin number, and/or biometric data, which may be used to authenticate the user. Biometric data may include a fingerprint scanner, iris scanner, facial information from a camera, etc. The authentication data may be stored in the account database 103 or third-party database 124 in an encrypted format, such that a hash is calculated based upon the received authentication data, which is then compared against a hash stored in the account database 110 or third-party database 124 corresponding to the provided authentication data. In some embodiments, authorizing the user may comprise the use of a private key stored on a physical device, such as with a hardware cryptocurrency wallet.

In step 460, one or more account preferences may be received and stored for the user account in account database 110. Such preferences may include digital wallet applications and associated payment methods to associate with the user account. Payment methods may include a credit card, bank account, or peer-to-peer payment systems such as PayPal, Venmo, Zelle, etc. In some embodiments, a payment method may comprise a balance of cryptocurrency, such as Bitcoin, Ethereum, or a community-specific cryptocurrency. The payment method may include one or more of a credit card or account number, card or account holder name, contact information such as a billing address, etc. The payment method may further comprise means of authentication, such as a password, pin number, credit card verification number, etc. Account preferences may provide provisional access, such as for a dependent or secondary user. In an embodiment, a secondary user may be a spouse. In another embodiment, a secondary user may be a child. In some embodiments, account preferences may comprise linking or otherwise enabling parental controls to the user account. The account preferences may comprise a list of blocked or approved vendors, geographic constraints, vendor types, etc. Vendor types may be based on products or services sold. In an embodiment, a secondary user may only be able to make interactions within the local community. The secondary user may further be restricted to making interactions only from food vendors. In some embodiments, the secondary user may only be allowed to use one payment method, such as a geocentric interaction tracking platform server 105 specific currency. In some embodiments, the secondary user may have a spending limit which may be per interaction, per period of time, such as day, week, month, etc., and may further be limited to specific vendors, such as $50 at a grocery store, but only $10 at an ice cream shop. Likewise, the use of the user's account by a secondary user, such as a child, may trigger one or more notifications sent to a user's smartphone or other user device allowing the user to track the secondary user's interaction activity using the account. The user account and associated data may thus be registered and saved to account database 110 in step 470.

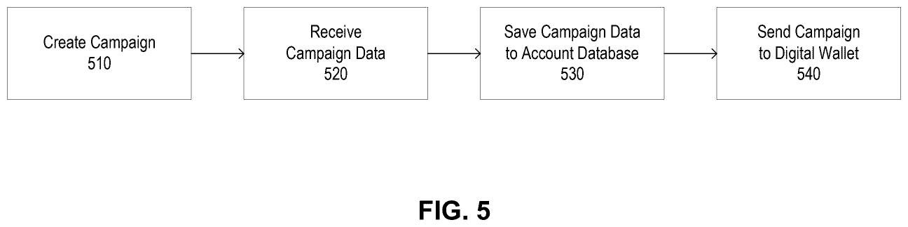

FIG. 5 is a flowchart illustrating an exemplary method for deploying new digital community campaigns. The process begins at step 510 in which the campaign module 130 is called by the interaction tracking engine 120 for execution. Execution of the campaign module 130 guides and facilitates generation of a new digital community campaign. A campaign may comprise any of a sale, promotion, event, etc. In some embodiments, a campaign may be limited to a single vendor within a neighborhood or community. In other embodiments, the campaign may involve multiple vendors within a neighborhood or community. In an embodiment, a campaign may be a sales promotion, such as offering double rewards. In another embodiment, the campaign may comprise an offer of a discount at a second vendor in return for a interaction made at a first vendor. In some embodiments, a campaign may comprise a fundraising effort, such as for a charity or local organization or cause. In an embodiment, a campaign is a fundraiser for the local high school's baseball team. In another embodiment, the campaign is a food drive for the local food shelf.

In step 520, campaign data—which may include the terms of the campaign, an organizer, participants, etc.—may be sent to and received at platform server 105. In an embodiment, a campaign may comprise a sales event where customers will be awarded double the normal amount of rewards, such as 6% instead of a normal rate of 3% of the interaction amount. The campaign data may further include a start time and end time, which may alternatively be described as a promotional period, or event duration. The campaign data may include a list of vendors comprising vendor IDs and/or vendor names. In an embodiment, the participating vendors for a campaign offering double rewards may include Bob's Burgers, Gary's Grocery, Theresa's Threads, and Shawn's Shoes. In some embodiments, vendors may participate in campaigns offering joint promotions, such as a the interaction of a pair of shoes at Shawn's Shoes may earn a free drink and fries with the interaction of a burger at Bob's Burgers. In some embodiments, the campaigns may include contributions from the revenue or profits of the vendors participating in the campaign. For example, if double rewards are offered, the default reward amount may be contributed by the operator of the geocentric interaction tracking platform server 105, whereas any additional rewards, such as an additional 3% to double the user's earned rewards for a interaction would be contributed by each participating vendor. In some embodiments, a campaign may include the allocation of funds, which may be provided in the form of a community-specific cryptocurrency, intended to pay for expenses incurred during the campaign. In some embodiments, a campaign may comprise a vendor committing to donate a percentage of each user interaction to a local community organization, such as a high school baseball team or a local food shelf.

At step 530, the campaign data for the new campaign may be stored in memory of the account database 110 for access by the interaction tracking engine 120, as well as sent to user devices 165 and digital wallets 170 for configuration and setup as to tracking in accordance with the parameters and rules of the new campaign.

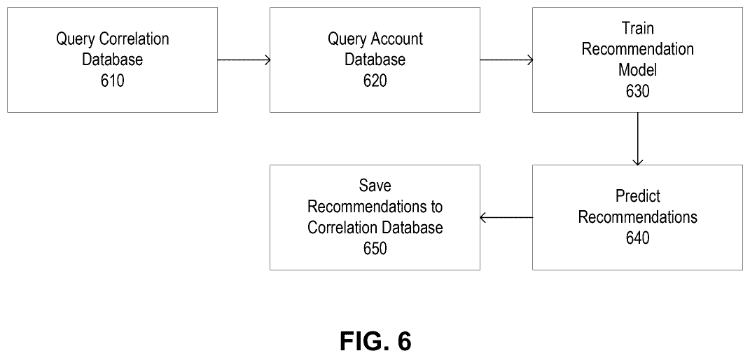

FIG. 6 is a flowchart illustrating an exemplary method for generating AI-based recommendations for community digital wallet usage. The process begins at step 610 in which the recommendation module 135 is called by the interaction tracking engine 120 for execution. The recommendation module 135 may by executed to query the correlation database 702 for correlation data, which may include quantified relationships between customers' behaviors, including the likelihood of purchasing a product or service after purchasing a different product or service. Alternatively, the relationships may represent interest in products based on which products the user has considered or vendors they have visited. In some embodiments, the relationships may be between the user's search or social media history and entity systems 175 with which the user device 165 of the user previously interacted. The relationships may relate to a specific user. In other embodiments, the relationships may relate to groups of similar users with similar demographics and behaviors.

In step 620, the account database 110 may be queried for user behavior data. User behavior data may comprise receipts or interaction history, search history, a history of vendors visited, whether physical or digital locations, items returned, etc. In some embodiments, the user behavior data may comprise data from third-party networks 122, such as social media sites, search engines, and vendors that are not part of a geocentric interaction tracking platform server 105.

In step 630, a recommendation model may be trained to make interaction recommendations for the user. The recommendations may be generated using a machine learning or artificial intelligence model trained using correlated data, which may use the user's previous behaviors as detected by user device 165 and entity systems 175, such as interactions, vendors visited, internet browsing history, etc., to predict specific entities, products, and/or interactions that may be of interest to a user. In some embodiments, a campaign promotion or marketing material, such as an advertisement, video, image, coupon, etc., may be generated instead of a specific product or vendor recommendation. Campaigns may comprise promotional events or may comprise other community events such as fundraising campaigns. In some embodiments, user feedback from users may be received which may be used to further train and refine the recommendation engine. In a simple example, if the recommendation engine were predicting the likelihood of a user purchasing a reading light if they previously purchased an eBook reader, the recommendation engine may predict that a user will interaction a reading light, however if the known result is no, the algorithm may be updated to decrease the likelihood of recommending a reading light to a user in future predictions. The relationship between the likelihood of purchasing both items may be represented by a correlation coefficient, or R value. The higher the correlation coefficient, the more likely that likelihood of purchasing one item is a predictor of purchasing the other item.

In step 640, one or more predications may be made for use in generating interaction recommendations for the user using the recommendation engine. The recommendations may be generated using a machine learning or artificial intelligence model trained using correlated data, which may use the user's previous behaviors, such as interactions, vendors visited, internet browsing history, etc., to predict products and/or vendors that may be of interest to a user. In some embodiments, a campaign promotion or marketing material, such as an advertisement, video, image, coupon, etc., may be generated instead of a specific product or vendor recommendation. Campaigns may comprise promotional events or may comprise other community events such as fundraising campaigns. In some embodiments, user feedback from users may be received which may be used to further train and refine the recommendation engine. In step 650, the recommendations may be stored to the account database 110.

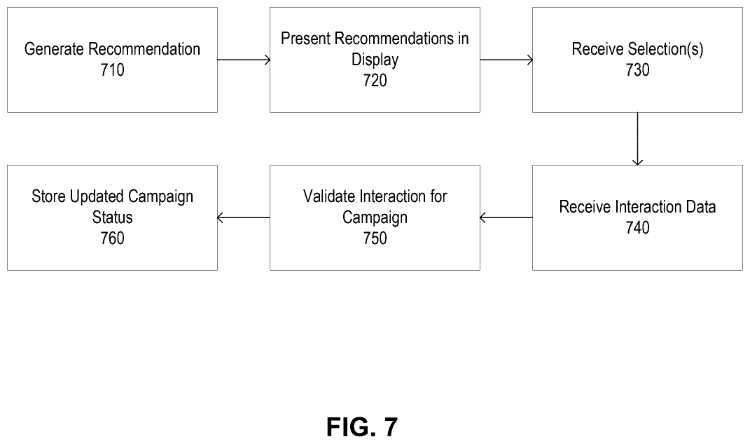

FIG. 7 is a flowchart illustrating an exemplary method for tracking recommendation conversion. The process begins at step 710 in which the interaction module 140 is called by the interaction tracking engine 120 for execution. The interaction module 140 may be executed to generate and track one or more interaction recommendations for the user. The recommendations may be generated using a machine learning or artificial intelligence model trained using correlated data, which may use the user's previous behaviors, such as interactions, vendors visited, internet browsing history, etc., to predict products and/or vendors that may be of interest to the user. In some embodiments, the recommendations may alternatively be selected from a table of product promotions. In some embodiments, recommendations may relate to a specific campaign. In some embodiments, a campaign promotion or marketing material, such as an advertisement, video, image, coupon, etc., may be generated instead of a specific product or vendor recommendation. Campaigns may comprise promotional events or may comprise other community events such as fundraising campaigns. In an embodiment, a product recommendation includes a reading light, as the user previously bought a paperback book.

In step 720, one or more recommendations may be provided to the user device 165 for rendering and display. In some embodiments, the recommendations may comprise specific products similar to products with which the user has previously interacted. In other embodiments, the recommendations may comprise a vendor similar to vendors they have interacted with in the past. In another embodiment, the product recommendations may comprise a campaign the user may be interested in, such as a promotional event or sale within the community or neighborhood. In a further embodiment, a campaign may comprise a fundraising campaign for a local organization, such as a high school baseball team. In some embodiments, the product recommendations displayed to the user may comprise multiple prices based on the payment method used. For example, the price paid using a traditional payment method may be higher than the price in a digital currency, which may not require external transaction fees.

In step 730, one or more selections may be received from the user device 165. In an embodiment, receiving selections may include product selections such as for a reading light, which was recommended by the recommendation engine. In another embodiment, the user may interact with an eBook reader. In another embodiment, the user may choose to interact with a service, such as making a salon appointment for a hair cut and blow-dry. Data regarding the interaction may be captured by a digital wallet 170 on the user device 165, which may also have been authenticated by the user using a password, passcode, facial data, or other biometric data. The details regarding the digital wallet and transaction may also be associated with the user account stored by account database 110 of geocentric interaction tracking platform server 105. In some embodiments, the payment method may not be stored in the account database 110 and may instead be provided by the user. In some embodiments, the payment method may comprise a gift card, reward credit, or currency, such as a cryptocurrency for use with the geocentric interaction tracking platform server 105. In some embodiments, multiple payment methods may be received such that one payment method may be used to cover part of the interaction price of the products and/or services selected by the user. For example, the user may use a gift card valued at $20.00 towards a $45.00 interaction and may then provide credit card information to pay for the remaining $25.00 balance. Similarly, a user may choose to use an earned reward credit, which may comprise a cryptocurrency, to cover part or all of the interaction amount.

The interaction data may be sent by the user device 165 and received at platform server 105. In step 750, the interaction data may be validated for one or more campaigns. Digital wallet applications 175 on the user device 165 may capture and transmit data associated with certain interactions (e.g., check-ins, transactions), including date, time, identifier of the entity system 175, geographic location, type of interaction, specific products or services associated with the interaction, amount of transaction, etc. In some implementations, other types of data and metadata (e.g., captured by other applications on user device 165) may also be transmitted to platform server 105 in addition to the interaction data from the digital wallet application 175. Execution of the transaction may comprise the use of one or more third-party network server 155 resources such as a financial service clearing house. In some embodiments, the transaction may be partially or entirely executed by the geocentric interaction tracking platform server 105. For example, if the interaction amount is less than an account balance of geocentric interaction tracking platform server 105 specific currency, such as a reward credit or cryptocurrency, the transaction may be executed by reducing the balance of the geocentric interaction tracking platform server 105 without submitting transaction or payment data to a third-party network such as a financial service clearing house. In some embodiments, rewards may be higher for transactions that can be entirely completed via the geocentric interaction tracking platform server 105 without requiring an external payment processor. In an embodiment, the transaction is executed by decreasing the payment amount by $20.00 and reducing the balance of a gift card to $0.00 and submitting a transaction to a financial service clearing house for a balance of $25.00 to be paid via a provided credit card number and additional billing information including the account holder's name, billing address, etc. Such details regarding the interaction may be compared to the rules and parameters of the campaign(s) in which the user is participating to determine whether the interaction indicated by the data earns any rewards in accordance with the evaluated rules and parameters.

In step 760, the interaction data may be used to update the user account and associated status or progress towards reward(s), as well as stored to the account database 110. The interaction data regarding specific products and/or services indicated by the interaction data may be used to identify progress or earning of certain rewards under the rules of a campaign. In some embodiments, the saved interaction data may further include updated account balances for a digital wallet, reward credit, and/or geocentric interaction tracking platform server 105 specific cryptocurrency. In some embodiments, the interaction data may be saved to a blockchain to create a ledger of transactions executed by the geocentric interaction tracking platform server 105. Sending at step 814, the interaction data to the interaction tracking engine 120.

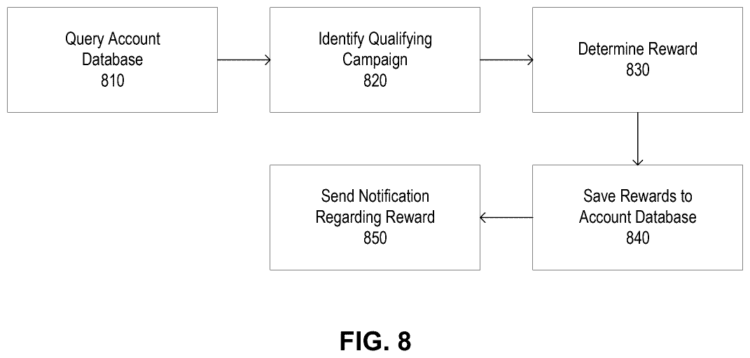

FIG. 8 is a flowchart illustrating an exemplary method for tracking community rewards for community digital wallet usage. The process begins at step 810 in which the rewards module 145 is called by the interaction tracking engine 120.

In step 820, the account database 110 may be queried for interaction data. The interaction data may indicate products and/or services associated with interactions, as well as the community entity associated with the entity system 175, digital wallet, and payment method(s) used in the interaction The interaction data may additionally include data relating to campaigns the transaction may have been part of, such as a marketing campaign, sales promotion, or fundraising campaign.

In step 830, the interaction may be identified as qualifying for one or more campaigns. For example, determining whether the transaction was made as part of a local campaign, sales, donations, or fundraising campaign. In an embodiment, the qualifying campaign is a double rewards such that all interactions earn 6% in rewards instead of the base 3% rewards. Such rewards may be provided as a discount on the current or future interactions, or as a geocentric interaction tracking platform server 105 specific currency, such as a cryptocurrency. In another embodiment, the campaign may have been a fundraising campaign, such that any earned rewards, such as 1.5%, or 3% of the interaction price may be donated to the campaign beneficiary, such as a local high school baseball team.

In step 840, the reward may be determined and used to update user account status. Depending on the specific campaign, points or other type of digital rewards may be determined and assigned to a user account, e.g., based on a defined rate, such as 3% of a donation transaction, or amount of time spent participating in a community event. In some embodiments, the reward amount may depend on the type of interaction and/or vendor. For example, interactions from local vendors may earn the user up to 3% in rewards, whereas interactions via a geocentric interaction tracking platform server 105 from non-local vendors, such as Amazon.com, Best Buy, etc., may instead earn up to 1.5%. For example, a user spending $20.00 at a local vendor may earn $0.60 in rewards at a rate of 3%, whereas the same interaction from a non-local vendor may earn $0.30 in rewards at a rate of 1.5%. The amount of rewards earned from local interactions and/or non-local interactions may be determined by the administrator of a geocentric interaction tracking platform server 105 and may vary by type of vendor, vendor, product, service, etc. In some embodiments, the amount of rewards earned may vary based on community or neighborhood. In some embodiments, the rewards may be transferrable between communities. In other embodiments, rewards may be restricted to use only in a single specific community or neighborhood. In some embodiments, rewards may be earned by a user on behalf of another organization. For example, a user may complete a transaction as part of a campaign to raise funds for a high school baseball team such that the earned rewards are instead allocated to the high school baseball team instead of the user's account.

In step 850, a notification regarding the updated rewards status may be sent to the user device 165. In an embodiment, a user made a $20.00 interaction at a local vendor and earned $0.60 at a rate of 3% in rewards. In another embodiment, the user made the $20.00 interaction from a local vendor during a campaign promising double rewards, earning $1.20 at a rate of 6%, double the normal 3% rate. In another embodiment, the user made a $20.00 interaction from a non-local vendor, earning $0.30 at 1.5% of the interaction price. In such examples, the rewards are distributed by being credited to a user's account or digital wallet. The credits may be provided as an increase in balance in the local currency. In some embodiments, the credits may be provided in a geocentric interaction tracking platform server 105 specific currency, which may be in a local currency equivalent value or may be a cryptocurrency. In some embodiments, the rewards may be allocated to an organization different than the user, such as if the user made a interaction as part of a campaign to raise funds for a local organization, such as a local high school baseball team. In some embodiments, a campaign may be organized to benefit an organization outside of the local community or neighborhood, such as efforts to raise funds for a charity, research initiative, etc. The earned and distributed awards and new account balances may be stored in account database 110 for access and later analyses by the interaction tracking engine 120.

FIG. 9 illustrates an exemplary computing system 900 that may be used to implement an embodiment of the present invention. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for managing community-specific digital campaigns, the method comprising:
storing information in memory regarding a plurality of different communities, each community associated with a geographic location and set of community-based entities associated with the geographic location;
receiving interaction data sent over a communication network from a user device, the interaction data automatically generated by the user device and indicating a geographic location of an interaction between the user device and an entity system;
determining that one of the communities is associated with the geographic location indicated by the interaction data;
verifying that the entity system indicated by the interaction data is associated with one of the community-based entities in the stored set for the determined community; and
storing the verified interaction data in memory in association with other verified interaction data regarding the user device and one or more of the community-based entities in the set associated with the determined community.

2. The method of claim 1, wherein the interaction data is automatically generated by a digital wallet application on the user device when the interaction occurs.

3. The method of claim 1, further comprising storing campaign data for a campaign at the geographic location in memory, wherein the campaign data includes a set of rules that define one or more parameters of an interaction required to earn a specified reward.

4. The method of claim 3, further comprising determining an amount of progress towards the specified reward for the user device based on the verified interaction data in accordance with the set of rules.

5. The method of claim 4, further comprising determining a total amount of progress toward the specified reward based on the amount of progress associated with the verified interaction data and an amount of progress associated with the other verified interaction data.

6. The method of claim 4, further comprising determining a total amount of progress toward the specified reward based on a combination of the verified interaction data with the other verified interaction data.

7. The method of claim 3, wherein the campaign specifies a nonprofit organization as recipient of the specified reward, and wherein the verified interaction data is further stored in association with other verified interaction data regarding one or more other user devices associated with the campaign.

8. The method of claim 1, further comprising generating a recommendation to send to the user device regarding an interaction using a machine learning model trained to correlate different interactions associated with the campaign.

9. The method of claim 7, further comprising tracking the recommendation in view of one or more subsequent interactions, wherein the machine learning model is further trained based on the tracked commendations and the subsequent interactions.

10. A system for managing community-specific digital campaigns, the system comprising:
memory that stores information regarding a plurality of different communities, each community associated with a geographic location and set of community-based entities associated with the geographic location;
a communication interface that communicates over a communication network to receive interaction data from a user device, the interaction data automatically generated by the user device and indicating a geographic location of an interaction between the user device and an entity system; and
a processor that executes instructions stored in memory, wherein the processor executes the instructions to:
determine that one of the communities is associated with the geographic location indicated by the interaction data, and
verify that the entity system indicated by the interaction data is associated with one of the community-based entities in the stored set for the determined community; and
wherein the memory further stores the verified interaction data in association with other verified interaction data regarding the user device and one or more of the community-based entities in the set associated with the determined community.

11. The system of claim 10, wherein the interaction data is automatically generated by a digital wallet application on the user device when the interaction occurs.

12. The system of claim 10, wherein the memory further store campaign data for a campaign at the geographic location, wherein the campaign data includes a set of rules that define one or more parameters of an interaction required to earn a specified reward.

13. The system of claim 12, wherein the processor executes further instructions to determine an amount of progress towards the specified reward for the user device based on the verified interaction data in accordance with the set of rules.

14. The system of claim 13, wherein the processor executes further instructions to determine a total amount of progress toward the specified reward based on the amount of progress associated with the verified interaction data and an amount of progress associated with the other verified interaction data.

15. The system of claim 13, wherein the processor executes further instructions to determine a total amount of progress toward the specified reward based on a combination of the verified interaction data with the other verified interaction data.

16. The system of claim 12, wherein the campaign specifies a nonprofit organization as recipient of the specified reward, and wherein the memory further stores the verified interaction data in association with other verified interaction data regarding one or more other user devices associated with the campaign.

17. The system of claim 10, wherein the processor executes further instructions to generate a recommendation to send to the user device regarding an interaction using a machine learning model trained to correlate different interactions associated with the campaign.

18. The system of claim 17, wherein the processor executes further instructions to track the recommendation in view of one or more subsequent interactions, and wherein the machine learning model is further trained based on the tracked commendations and the subsequent interactions.

19. A non-transitory, computer-readable storage medium, having embodied thereon a program executable by a processor to perform a method for managing community-specific digital campaigns, the method comprising:
storing information in memory regarding a plurality of different communities, each community associated with a geographic location and set of community-based entities associated with the geographic location;
receiving interaction data sent over a communication network from a user device, the interaction data automatically generated by the user device and indicating a geographic location of an interaction between the user device and an entity system;
determining that one of the communities is associated with the geographic location indicated by the interaction data;
verifying that the entity system indicated by the interaction data is associated with one of the community-based entities in the stored set for the determined community; and
storing the verified interaction data in memory in association with other verified interaction data regarding the user device and one or more of the community-based entities in the set associated with the determined community.
